(19) United States
(12) Patent Application Publication
(10) Pub. No.: US 2010/0228603 A1
(43) Pub. Date: Sep. 9, 2010

(54) CONTENT ALTERNATIVE MONETIZATION SYSTEM

(75) Inventors: Robert Bolder, Montclair, NJ (US); Lance Jackson, Yardley, PA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: nGage Behavior, LLC, Montclair, NJ (US)

(21) Appl. No.: 12/717,563

(22) Filed: Mar. 4, 2010

Related U.S. Application Data
(60) Provisional application No. 61/209,305, filed on Mar. 5, 2009.

(51) Int. Cl. G06Q 30/00; G06F 17/30; G06Q 50/00; G06Q 10/00

(52) U.S. Cl. 705/10; 707/769; 705/14.1; 707/802; 707/E17.005; 707/E17.014

(57) ABSTRACT

A system, method, and computer program product are provided for providing advertisements to users with verification that the user has viewed and understood the advertisement. As an incentive to view the advertisement, the user is provided with awards that can be redeemed for various goods and services. In an example, the user may redeem the awards for MP3 downloads, which the system obtains from a vendor system and stores in a staging area for provision to the user.

### CROSS-REFERENCE TO RELATED APPLICATIONS

The present application claims priority to U.S. Provisional Application No. 61/209,305, filed Mar. 5, 2009, entitled “Content Alternative Monetization System”, which is incorporated herein by reference in its entirety.

### BACKGROUND OF INVENTION

1. Field of the Invention

The present invention relates generally to monetization of digital content through the use of participatory advertisements.

2. Description of the Background Art

Online content providers presently make their content available to users through a variety of different access and download formats. For example, many online newspaper services have been moving to a subscription or pay-per-view format (e.g., micropayments). Other content providers continue to use the prevalent advertiser-supported model to provide the content free of charge to the end users. Revenue from advertisers is used to support continuous web site operations to provide the content, as well as to maintain existing content libraries and obtain new content.

These revenue models have been applied to a number of different content types. As noted, online newspapers have tried each of the various models in order to find the best ways to meet user demands while still satisfying any advertisers. Other media types such as downloadable music, software, or even streaming video, rely on similar revenue sources. Advertiser supported content models have even been extended to Internet Service Providers, with services such as NETZERO, INC. of Woodland Hills, Calif. providing advertiser supported Internet access.

Traditional ways of generating advertiser revenue rely on selling a particular advertisement space on a web page to an advertiser. This space is generally located physically near the content a user is attempting to access (e.g., a skyscraper advertisement on a side bar of a web page), or in other locations that attempt to draw a user's focus to the advertisement. The location may also be temporally inserted before a user may access content, or even shortly after. For example, interstitial advertisements often appear when a user selects a link for the content the user wishes to access, and the user must wait for the advertisement to be displayed for a certain amount of time before being allowed to proceed, for example. Other interstitial advertisements are inserted before or after streaming video content being provided to a user.

Content providers selling these advertisement locations to potential advertisers concentrate on using some of the aforementioned techniques to increase or draw a user's attention to that advertisement location. When it is believed that users will pay more attention to a particular advertisement location, advertisers are willing to pay more for the elevated effectiveness of an advertisement placed in this location in reaching a target audience.

However, many users choose to avoid viewing these advertisements altogether. This is accomplished through a conscious or subconscious effort on the part of the user to ignore advertisements through familiarity with a particular site layout. Users may learn where advertisements are located on a particular web site, and direct their attention away from these locations and instead to the means by which they can quickly retrieve desired content. This advertising fails to engage the user, and therefore is likely a waste of resources for the advertiser.

Other ways of avoiding advertisements involves more deliberate circumvention, such as advertisement blocking software available for most modern web browsers. What began as a way to block pop-up advertisements, which create a new browser window displaying an advertisement that the user must acknowledge to at least close the window, has evolved into a complex series of heuristics that can identify a large number of advertising techniques and prevent the advertisements from rendering to a requested web page in the first place.

As a result, many advertisers have replied with even more aggressive and intrusive advertising, and users retaliate with even more effective tools for blocking these advertisements. This escalation continues as advertising space becomes less and less valuable, as advertisers cannot reasonably rely on the expectation that users will actually view or remember the advertisement. Also, such advertising techniques may anger and thus prejudice the user against the advertiser, further reducing the value of the advertisement.

The problems with revenue generation in advertiser supported content models prevent the generation of sufficient revenue to support offerings of higher priced content. For example, an advertiser supported site offering MP3 music downloads would be unable to generate sufficient revenue when users who have become familiar with the site routinely bypass, or otherwise render ineffective or ignore, the very advertisements used to support the content provider's site. A user can download these MP3s, and play them back repeatedly without any further exposure to advertisements. Additionally, they may redistribute the MP3s to other users, who would themselves not be exposed to the advertisements needed to support distribution.

Many solutions to this problem also tend to penalize users who have paid for, and therefore own, title or license to content they wish to access. Such users are unlikely to tolerate advertising when accessing content they have paid for.

Accordingly, what is desired is a way to provide access to content using an advertiser-supported revenue model, where advertisements are given high value exposure that requires and encourages engagement by a user.

### SUMMARY OF INVENTION

Embodiments of the invention include a method comprising providing an advertisement, presenting a question based on the advertisement, receiving an answer to the question, and updating, by one or more computing devices, an award database to reflect an award, wherein the answer is correct.

Embodiments of the invention additionally include a computer-readable storage medium having instructions stored thereon that, when executed by a computing device, cause the computing device to perform a method comprising providing an advertisement, presenting a question based on the advertisement, receiving an answer to the question, and updating an award database to reflect an award, wherein the answer is correct.

Embodiments of the invention further include a system comprising a memory configured to store modules, the modules comprising: a providing module configured to provide an advertisement, a presenting module configured to present a question based on the advertisement, a receiving module configured to receive an answer to the question, and an updating module configured to update an award database to reflect an award, wherein the answer is correct, and a processor configured to process the modules.

Embodiments of the invention also include a method comprising receiving a request to purchase an electronic media file from an intermediary for provision to a user device based on redemption of an award, providing the electronic media file to the intermediary, and confirming deletion of the electronic media file by the intermediary subsequent to provision of the electronic media file to the user device by the intermediary.

Embodiments of the invention also include a method comprising uploading an advertisement for presentation to a user, uploading a question for presentation to the user, and a correct answer, wherein the user is presented with the question upon viewing the complete advertisement, configuring demographic information corresponding to target users for the advertisement, and monitoring statistical information of answers chosen by the user.

Embodiments of the invention also include a method comprising detecting, by one or more computing devices, a visit to an affiliate site from an affiliate site list, receiving notification of an event on the affiliate site, determining whether the event is an award event, and updating a central award database based on the award event.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form a part of the specification, illustrate embodiments of the present invention and, together with the description, further serve to explain the principles of the invention and to enable a person skilled in the relevant art to make and use the invention.

FIG. 1 is a content management system, in accordance with an embodiment of the present invention.

FIG. 2 is a flowchart illustrating steps by which a user of content manager is able to create and verify their identity, in accordance with an embodiment of the present invention.

FIG. 3 is an expanded view of a content manager, in accordance with an embodiment of the present invention.

FIG. 4 is a flowchart illustrating steps by which an advertisement is displayed and user engagement verified, in accordance with an embodiment of the present invention.

FIG. 5 is an advertiser's view of a content management system, in accordance with an embodiment of the present invention.

FIG. 6 is an expanded view of a content management system illustrating components used to provide content to a user, in accordance with an embodiment of the present invention.

FIG. 7 is a flowchart illustrating steps by which a relationship with a media vendor is established, in accordance with an embodiment of the present invention.

FIG. 8 is a flowchart illustrating steps by which a user chooses a reward to redeem acquired awards for, in accordance with an embodiment of the present invention.

FIG. 9 is a flowchart illustrating steps by which acquired media is provided to a user, in accordance with an embodiment of the present invention.

FIG. 10 is a flowchart illustrating download manager capabilities of agent software, in accordance with an embodiment of the present invention.

FIG. 11 is a flowchart illustrating steps by which agent software is able to extend functionality to affiliate sites, in accordance with an embodiment of the present invention.

FIG. 12 is a flowchart illustrating steps by which an intelligent agent is configured to refine demographic information for a user, in accordance with an embodiment of the present invention.

FIG. 13 depicts an example computer system in which embodiments of the present invention may be implemented.

The present invention will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

### I. Introduction

The following detailed description of the present invention refers to the accompanying drawings that illustrate exemplary embodiments consistent with this invention. Other embodiments are possible, and modifications can be made to the embodiments within the spirit and scope of the invention. Therefore, the detailed description is not meant to limit the invention. Rather, the scope of the invention is defined by the appended claims.

It would be apparent to one of skill in the art that the present invention, as described below, can be implemented in many different embodiments of software, hardware, firmware, and/or the entities illustrated in the figures. Any actual software code with the specialized control of hardware to implement the present invention is not limiting of the present invention. Thus, the operational behavior of the present invention will be described with the understanding that modifications and variations of the embodiments are possible, and within the scope and spirit of the present invention.

In order to support content distribution using advertisements (“ads”) on the Internet, it is important to provide advertising space that engages users and helps them remember the product or service being advertised. Advertisers are willing to pay high dollar amounts for this level of exposure, such that creating high quality advertising space becomes important in designing and supporting a content provider.

An exemplary embodiment disclosed herein describes a content provider for MP3 music downloads, although one skilled in the relevant arts will appreciate that any number of goods and services (or other reward) can be substituted for this exemplary content. The content is obtained in exchange for a user viewing an advertisement and verifying their understanding of the content, in accordance with a further embodiment of the present invention. Applications of the embodiments described herein outside of the particular context in which they are described are contemplated by the disclosure, and would be understood by one skilled in the relevant arts to be applicable to a number of different fields of endeavor.

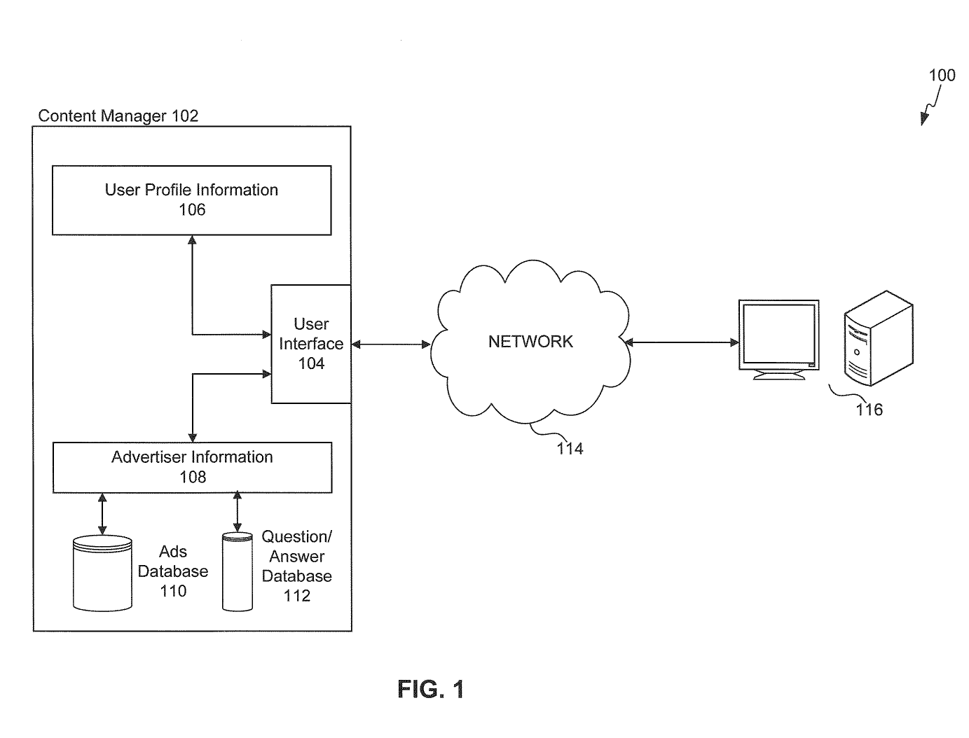

FIG. 1 is a content management system 100, in accordance with an embodiment of the present invention. The content management system 100 includes a content manager 102 that has a user interface 104, which a client device 116 can access via network 114, in accordance with an embodiment of the present invention. One skilled in the relevant arts will recognize that network 114 may be any type of communications network, including, by way of example and not limitation, the Internet. Client device 116 may be one of a personal computer, mobile device, or any other client computing platform configured to connect to user interface 104 over network 114.

Content manager 102 further includes a user profile information module 106, which is used to store account information for a particular user of content manager 102, in accordance with an embodiment of the present invention. This includes, for example, a login name and password for a user accessing content manager 102 from client device 116.

Content manager 102 also includes an advertiser information module 108 that interfaces an advertisement database 110 and a question and answer database 112. Advertiser information module 108 is used to select advertisements for display to a user via user interface 104 in a manner described below.

### II. Account Registration

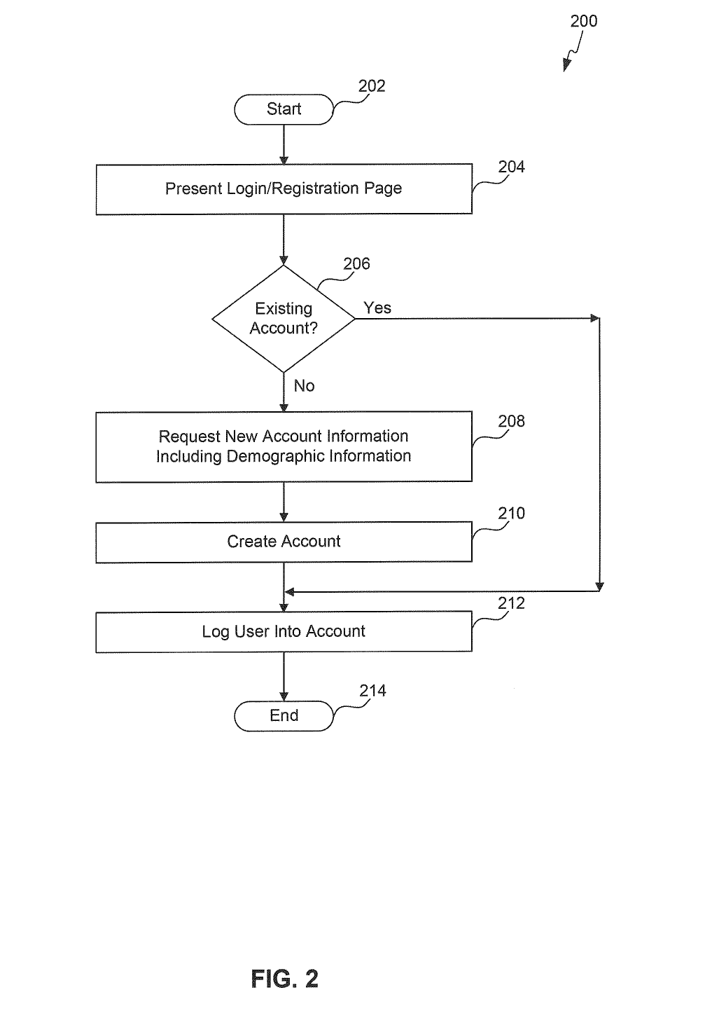

FIG. 2 is a flowchart 200 illustrating steps by which a user of content manager 102 is able to create and verify their identity, in accordance with an embodiment of the present invention. The method begins at step 202 and proceeds to step 204 where a user login/registration page is presented to the user, in accordance with an embodiment of the present invention. In accordance with an embodiment of the present invention, client device 116 is presented with the login/registration page upon first accessing user interface 104, although one skilled in the relevant arts will understand that alternate means of authentication are contemplated. By way of example, and not limitation, user interface 104 may be located entirely within client device 116, and provides backend communications to content manager 102. Such an approach may be used, for example, in the design of a mobile device application. In such an embodiment, the login/registration page would be integrated into the application itself, in accordance with a further embodiment of the present invention.

If the user already has an existing account 206, the user is able to enter credentials to identify themselves, and therefore log into their account at step 212. Otherwise, the user is requested to register for a new account at step 208.

New user registration is an opportunity to obtain identifying information regarding the user that can be used to select targeted advertisement of interest to that user. Demographic information, such as a user's age, gender, music interests, etc. are collected at this step 208, along with required credentialing information, such as a username and password, in accordance with an embodiment of the present invention. At step 210, an account is created for the user, and the user's information is stored in user profile information module 106, in accordance with an embodiment of the present invention. The newly-registered user can then log in at step 212, and the method ends at step 214.

### III. Advertising Engine

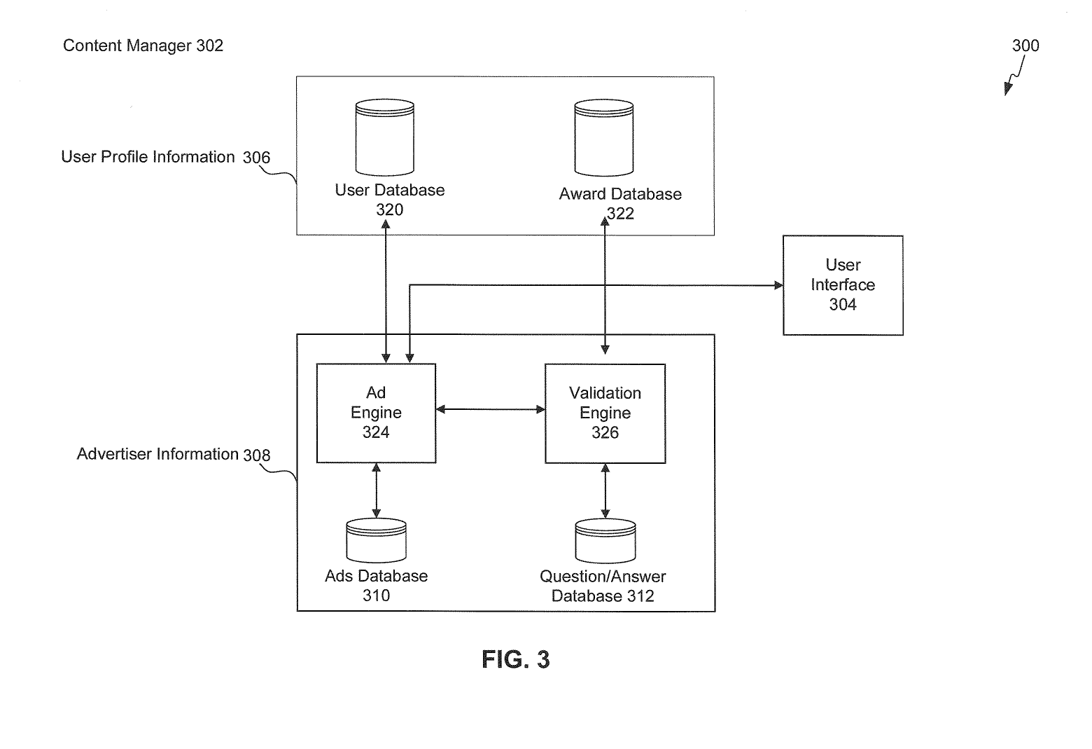

FIG. 3 is an expanded view of a content manager 302, in accordance with an embodiment of the present invention. Content manager 302 includes a user interface 304, which allows a user to view and respond to advertisements, in accordance with an embodiment of the present invention.

As with content manager 102, content manager 302 includes user profile information module 306, in accordance with an embodiment of the present invention. User profile information module 306 includes a user database 320, which is used to store information such as the aforementioned demographic data regarding a user, in accordance with an embodiment of the present invention. Award database 322 is used to store data regarding a user's collected awards, such as points, in accordance with an embodiment of the present invention. The function of award database 322 is described further below. One skilled in the relevant arts will recognize that the exact structure of user profile information module 306, such as the layout of user database 320 and award database 322 as, for example, separate tables of a same relational database, need not be precisely as shown in FIG. 3. The structure shown in FIG. 3 is presented by way of example, and not limitation.

Content manager 302 further includes advertiser information module 308, in accordance with an embodiment of the present invention. Advertiser information module 308 includes an advertising engine 324 configured to serve advertisements from advertisement database 310, in accordance with an embodiment of the present invention. Advertisements stored in ads database 310 may be of a variety of different content types, including, by way of example and not limitation, video, text, graphics, or audio, or some combination thereof.

Ad engine 324 is configured to select advertisements from ads database 310 and present the selected advertisement to a user via user interface 304, in accordance with an embodiment of the present invention. As previously indicated, user interface 304 need not be located within content manager 302, and may instead be located, for example, within a user device which accesses content manager 302 to receive data for display within user interface 304. This data includes, for example, advertisements served by ad engine 324.

Advertiser information module 308 further includes a validation engine 326, which is connected to a question and answer (“Q&A”) database 312, in accordance with an embodiment of the present invention. One skilled in the relevant arts will recognize that the precise layout of advertiser information module 308, as with any other aspect of the disclosure, need not be precisely as shown in FIG. 3, and is presented by way of example, and not limitation. Validation engine 326 is operatively connected to the award database 322 to provide a user with an award based on a correct answer of a question from Q&A database 312.

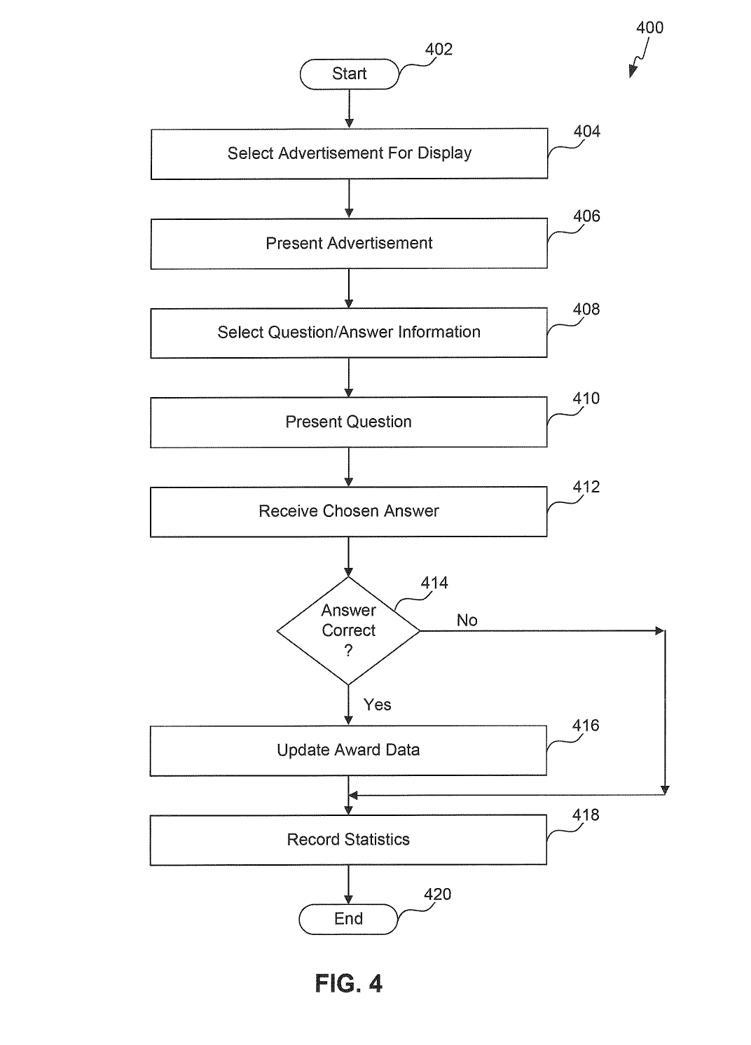

FIG. 4 is a flowchart 400 illustrating steps by which an advertisement is displayed and user engagement verified, in accordance with an embodiment of the present invention. Flowchart 400 is described with continuing reference to content manager 302 of FIG. 3.

The method begins at step 402 and proceeds to step 404 where an advertisement is selected for display. This is accomplished, in accordance with an embodiment of the present invention, by ad engine 324 receiving a request for an advertisement from user interface 304. One skilled in the relevant arts will recognize that a request to provide an advertisement may be received from a number of different sources, and the use of user interface 304 as the requestor, whether located within content manager 302 or elsewhere, is provided by way of example and not limitation.

In response, ad engine 324 accesses ads database 310 to retrieve an advertisement to display to a user, in accordance with an embodiment of the present invention. In accordance with a further embodiment of the present invention, the advertisement is selected based on a user's demographics information and other information identified as relevant to the selection of a particular advertisement. Ad engine 324 is able to access user database 320 to retrieve available information for the user used to select the ad for display. One skilled in the relevant arts will recognize that other factors, such as how recently a particular ad or ads from an advertiser was shown to the user, may be used to determine which advertisement should be selected by ad engine 324.

In accordance with a further embodiment of the present invention, an advertiser provides parameters for displaying the advertisement, such as criteria for a user's demographics information, frequency at which to display the advertisement, geographic areas in which to run the advertisement, and other controls used to improve the likelihood that the advertisement is shown to a relevant user. These parameters are taken into account by ad engine 324 in the selection of an advertisement from ads database 310.

At step 406, the advertisement is presented to the user, in accordance with an embodiment of the present invention. The advertisement may be of any form, such as audio, video, a slide show of images, scrolling text, or any other form or combination of forms of advertisement now existing or developed in the future. In a further embodiment of the present invention, the advertisement is presented in a prominent position on the user interface 304. For example, if the advertisement is displayed on a web page, a user may move a cursor over the advertisement, causing the advertisement to automatically enlarge to full size and audio and video to begin (e.g., using a roll-over effect), and the advertisement will continue to play while the user's cursor remains hovering over the advertisement. Moving the cursor away returns the advertisement to its original size, and the advertisement stops playing. This exemplary embodiment is just one way in which a particular advertisement type, in this case video content, may be displayed. One skilled in the relevant arts will recognize that other ways of presenting the advertisement may be used, and are contemplated by the disclosure.

When the advertisement has been fully presented to a user, such as when a video has been watched in its entirety, the method proceeds to step 408 where Q&A information corresponding to the advertisement is retrieved. One skilled in the relevant arts will recognize that the steps shown in flowchart 400, or in any flowchart, need not be performed in the order in which they are depicted. For example, the Q&A information of step 408 may be retrieved together with the advertisement selected for display at step 404.

In accordance with an embodiment of the present invention, validation engine 326 selects a question and one or more answers from the Q&A database 312. In an embodiment of the present invention, the Q&A database stores question and answer sets in the form of multiple choice questions, such that one question corresponds to two or more answers in the same set. One skilled in the relevant arts will recognize that other techniques for indicating corresponding answers may be used, and is not limited to the techniques presented herein by way of example, and not limitation.

The questions and answers are randomly selected from one or more sets of questions and answers associated with a particular advertisement, in accordance with an embodiment of the present invention. In accordance with a further embodiment of the present invention, advertisers can provide multiple sets of questions and answers to prevent reuse of repetitive questions and answers. In accordance with an additional embodiment of the present invention, the questions and answers for a particular advertisement are selected by applying knowledge of user demographic information.

At step 410, validation engine 326 provides the selected question to the user, in accordance with an embodiment of the present invention. This question is written to test knowledge of the advertisement that was just presented to the user at step 408, in accordance with an embodiment of the present invention. In the case of a multiple choice question, two or more answer choices corresponding to the question are presented to the user as well to choose from. The user then enters an answer, either by selecting an available answer, in the case of multiple choice, or by providing some other entry type.

The user's chosen answer is received at step 412, and a determination is made at step 414 as to whether the answer is correct. If the user's answer is correct, the method proceeds to step 416 where the user's award data is updated, in accordance with an embodiment of the present invention. In accordance with a further embodiment of the present invention, a user's information in award database 322 is updated to reflect an award corresponding to correctly answering the question. This may reflect, by way of example and not limitation, the award of one or more reward points, which are used as redeemable currency as described in further detail herein. Alternatively, products and/or services may be awarded. In accordance with an additional embodiment of the present invention, the user is immediately directed to requested content as an award.

If the user has chosen an incorrect answer to the question, a new question is presented to the user to answer, in accordance with an embodiment of the present invention. In accordance with a further embodiment of the present invention, an entire new advertisement, along with a corresponding new question, is presented to the user and the method restarts from step 402.

Whether or not the answer was correct, the method then proceeds to step 418 where statistics regarding the user's chosen answer are recorded. This allows advertisers to access content manager 302 and view user responses, or information statistically derived therefrom, to gauge user retention of the advertisement, the quality or effectiveness of the advertisement and/or question, or whether the questions are too easy or too hard, for example. The method then ends at step 420. In accordance with a further embodiment of the present invention, information regarding a user's attitude towards the advertisement is collected, such as by asking the user whether they liked or disliked the advertisement. This information is also included with the statistics.

In accordance with a further embodiment of the present invention, the aforementioned technology can be licensed to a third party for embedding within their own software or hardware configurations. For example, a third party licensee can leverage the technology to award points when a user registers on their site. In accordance with an additional embodiment of the present invention, points can be shared through central management by content manager 302, allowing the points to be redeemed for all available rewards regardless of their source. Use of licensed technology by affiliate sites is described in further detail below.

### IV. Advertiser View

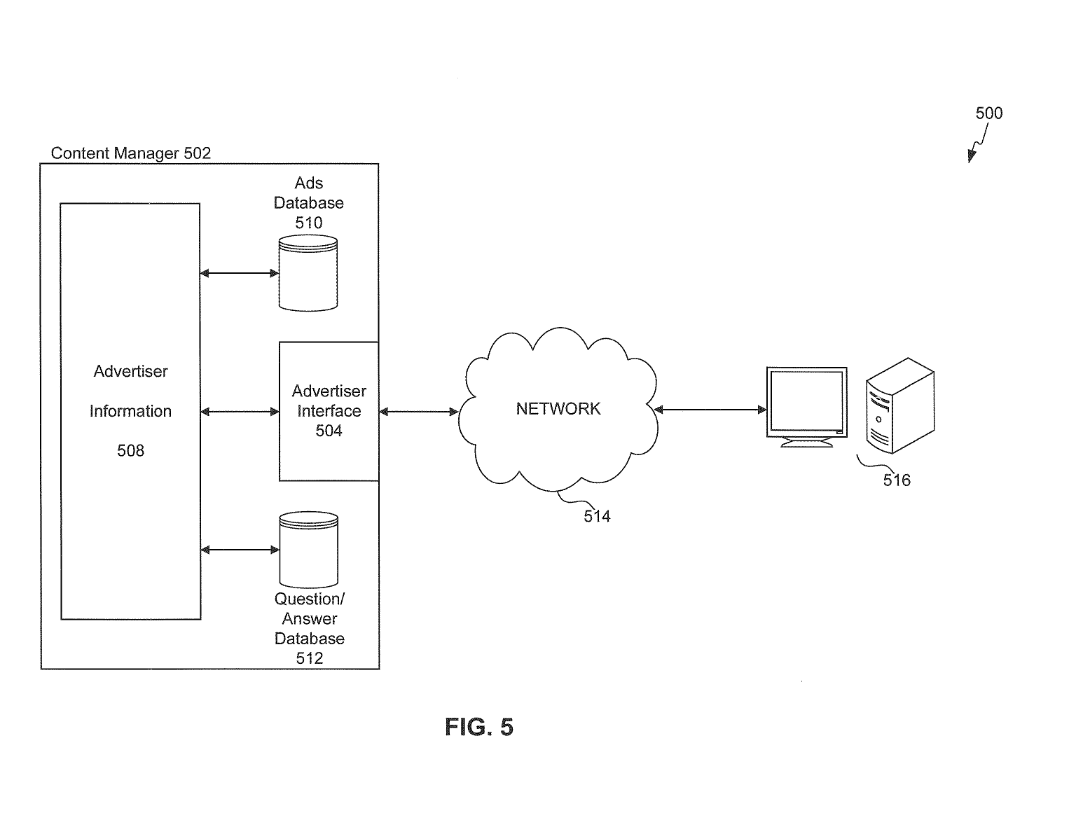

FIG. 5 is an advertiser's view of content management system 500, in accordance with an embodiment of the present invention. Content manager 502 is used to select and serve advertisements to users and track reward information. However, in order to have advertisements and questions to present to a user, content manager 502 is configured to allow an advertiser 516 to manage the advertiser's account on content manager 502, in accordance with an embodiment of the present invention.

An advertiser interface 504 is configured to accept connections from an advertiser 516 over network 514, in accordance with an embodiment of the present invention. One skilled in the relevant arts will appreciate that advertiser interface 504 need not be located on content manager 502, and may instead be located, for example, within advertiser 516's own computing device, providing an interface to advertiser information module 508.

Advertiser information module 508 interfaces several advertiser-specific sections of content manager 502. For example, advertiser information 508 interfaces with ads database 510 and Q&A database 512. This allows an advertiser 516 to upload new advertisements to ads database 510, in accordance with an embodiment of the present invention. In accordance with a further embodiment of the present invention, advertiser 516 uses this interface to manage all aspects of the advertising campaign, including billing, frequency of ads, target demographics, etc.

Advertiser interface 504 also provides advertiser 516 with the ability to manage the Q&A database by adding, deleting, or modifying question and answer sets, in accordance with an embodiment of the present invention. In accordance with a further embodiment of the present invention, advertiser 516 is able to access statistical information regarding shown advertisements and users' answers to questions selected from Q&A database 512.

### V. Award Redemption

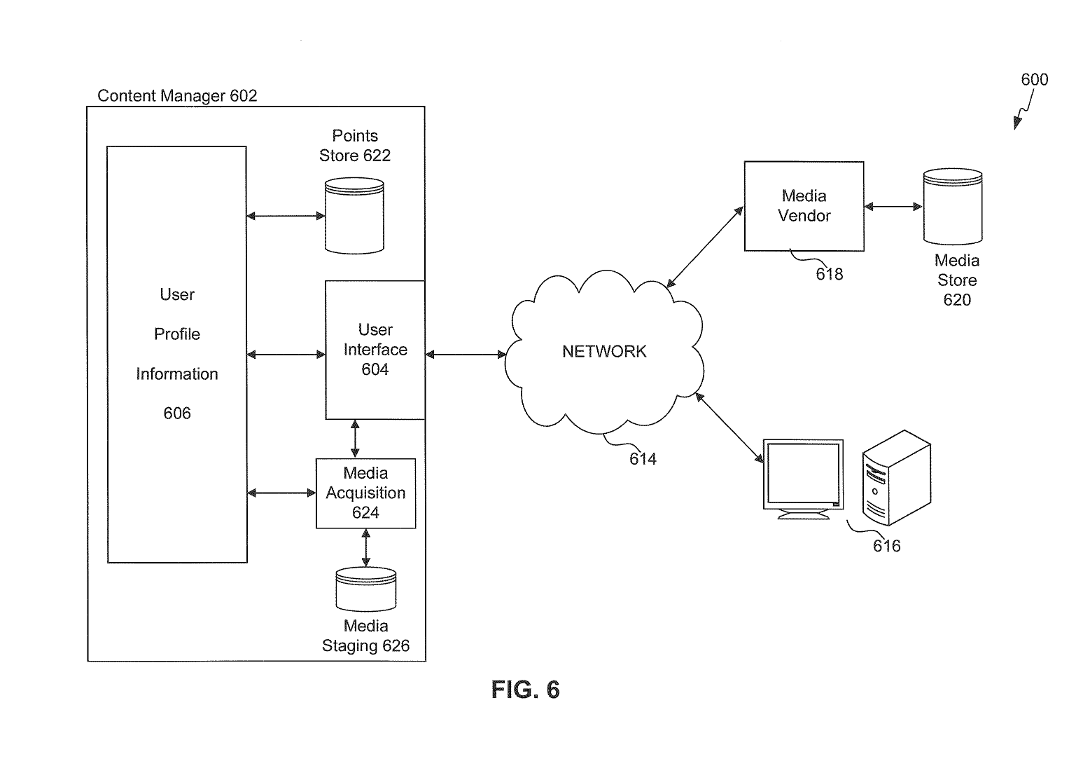

FIG. 6 is an expanded view of content management system 600 illustrating components used to provide content to a user (or other award items, such as but not limited to products and/or services), in accordance with an embodiment of the present invention. User interface 604 is configured to allow a user operating user device 616 to connect over network 614 in order to access the user's profile information 606 within content manager 602, in accordance with a further embodiment of the present invention.

A user can access user interface 604 to, for example, check on awards accumulated by the process described, inter alia, in Section III, supra. The current status of a user's awards is retrieved from points store 622, and can be presented to the user via user interface 604, in accordance with an embodiment of the present invention.

In an embodiment where the awards comprise media, such as songs and/or videos, content manager 602 further includes a media acquisition module 624 and a media staging area 626, in accordance with an embodiment of the present invention. Media acquisition module 624 is configured to identify one or more sources for a user's desired content, such as media vendor 618 with desired content stored in media store 620, and present the user with the ability to request the content offered by media vendor 618. Media acquisition module 624 can acquire the media from media vendor 618, store it in media staging area 626, and then provide it to client device 616, in accordance with an embodiment of the present invention.

One skilled in the relevant arts will recognize that media acquisition module 624 is not necessary in every instance, such as when media vendor 618 is integrated into content manager 602, in accordance with an embodiment of the present invention. Moreover, one skilled in the relevant arts will appreciate that content provided by media vendor 618 need not be media, and can be other goods and services, including physical goods.

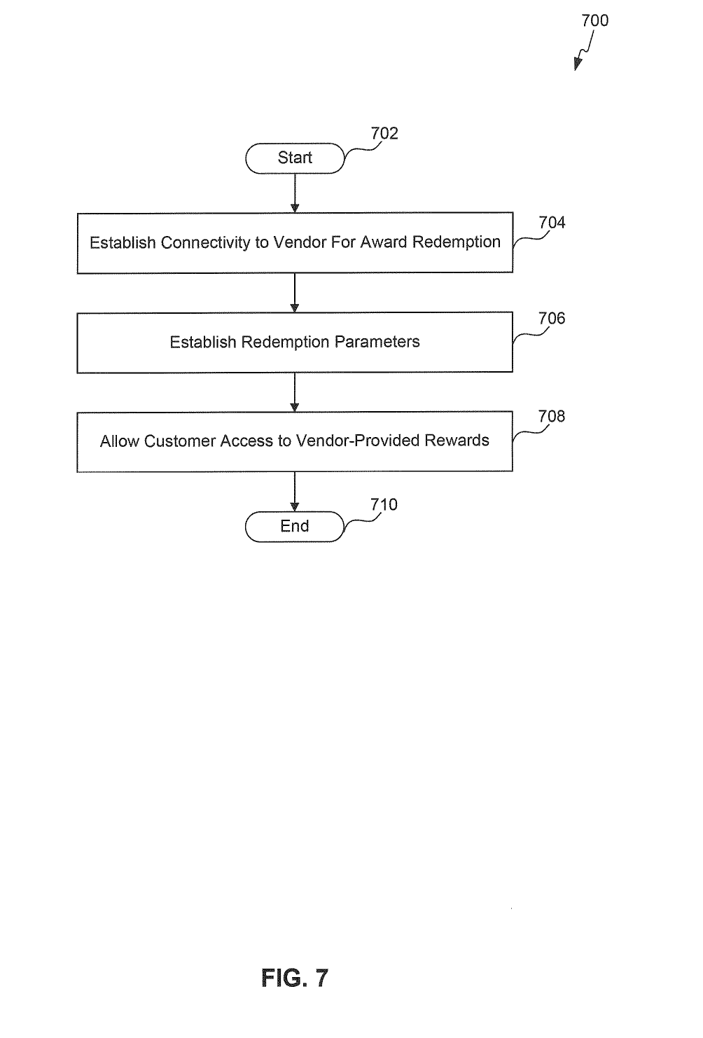

By way of example, and not limitation, the functionality of content management system 600 is presented using the example of MP3 audio downloads from media vendor 618. FIG. 7 is a flowchart 700 illustrating steps by which a relationship with a media vendor is established, in accordance with an embodiment of the present invention. The method begins at step 702 and proceeds to step 704 where connectivity to a vendor is established for award redemption. This process entails, for example, configuring media acquisition module 624 to search media vendor 618 for available goods and services. In the case of an MP3 storefront, media vendor 618 may have particular protocols for downloading MP3s, including a particular payment arrangement. Additionally, media vendor 618 may have legal limitations on access, including limits on downloads of MP3s, for example. Media acquisition module 624 is therefore configured to abide by these requirements when contacting media vendor 618.

At step 706, redemption parameters are established, in accordance with an embodiment of the present invention. As previously noted, answering a question about an advertisement correctly nets a user an award, in accordance with an embodiment of the present invention. In accordance with a further embodiment of the present invention, this award is in the form of one or more points, redeemable for goods and services sold by media vendor 618. Accordingly, at step 706, the exchange rate for points to particular goods and services provided by media vendor 618 is established. Then, at step 708, users are able to use this exchange rate to legally purchase and obtain goods and services from media vendor 618, in accordance with an embodiment of the present invention. The method then ends at step 710.

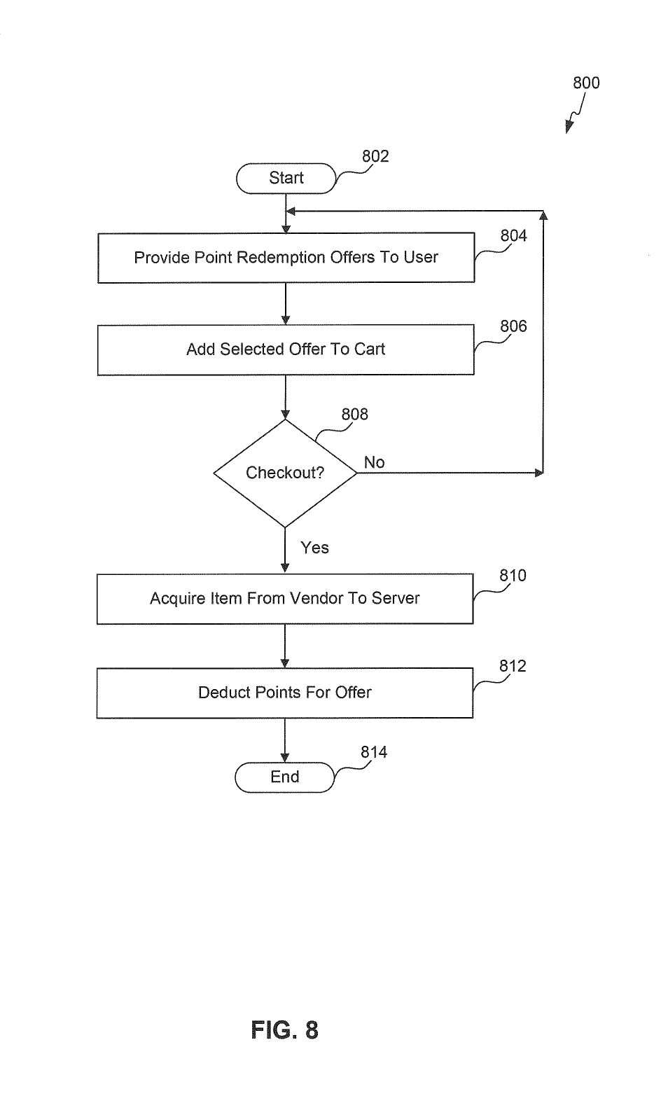

FIG. 8 is a flowchart 800 illustrating steps by which a user chooses a reward to redeem acquired awards for, in accordance with an embodiment of the present invention. The method begins at step 802 and proceeds to step 804 where available point redemption offers are presented to the user, in accordance with an embodiment of the present invention. In the case of MP3 downloads, MP3s available for download from media vendor 618 are presented to the user along with their corresponding point values. In accordance with an embodiment of the present invention, the offers presented to the user and corresponding point values are determined through the utilization of an agent based search that evaluates various suppliers, pricing, and availability. The user can then select from these offers to add one or more offers to a cart at step 806, in accordance with an embodiment of the present invention.

If the user does not have enough points to purchase the selected offers (e.g., MP3s), the user is presented with the option to continue viewing advertisements in order to acquire additional points, in accordance with an embodiment of the present invention. This encourages user retention and participation through tight integration of the advertisement component with the store front.

Once the user has made a selection of offers for which the user has sufficient points, the user has the option to checkout at step 808. If the user does not wish to checkout, the user may continue viewing point redemption offers 804 and managing the shopping cart at step 806.

If the customer is ready to checkout, the customer's requested MP3s are acquired from media vendor 618, in accordance with an embodiment of the present invention. In accordance with a further embodiment of the present invention, media acquisition module 624 interfaces with media vendor 618 and provides any necessary payment in order to acquire and download requested data from media store 620. The requested data, in this case in the form of an MP3, is then stored in media staging area 626, in accordance with an embodiment of the present invention. The data held in media staging area 626 is associated with the user for future retrieval.

One skilled in the relevant arts will recognize that this technique can be applied to other forms of electronic and physical goods and services, such as, by way of example and not limitation, a newspaper article, a video, a subscription service, etc.

With the acquired media stored in media staging area 626, the corresponding number of points are deducted from the user's points store 622 at step 812, in accordance with an embodiment of the present invention. The method then ends at step 814.

### VI. Media Acquisition

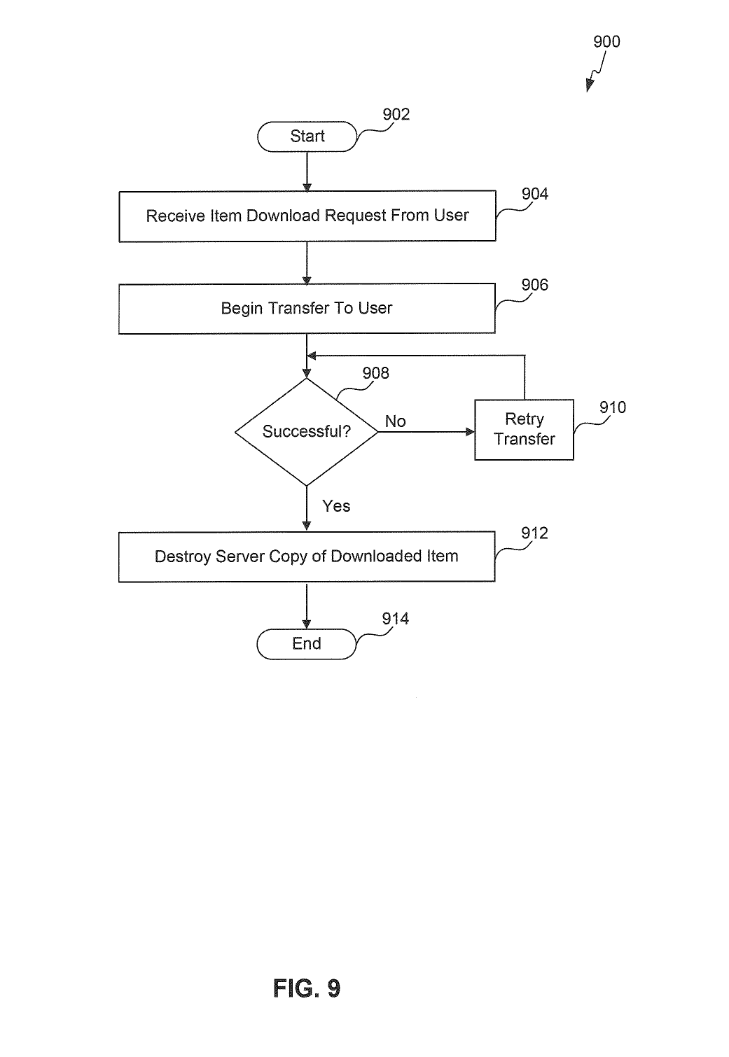

FIG. 9 is a flowchart 900 illustrating steps by which acquired media is provided to a user, in accordance with an embodiment of the present invention. In this example, some form of media, such as an MP3, has been acquired from media vendor 618 by media acquisition module 624 and stored in media staging area 626. Flowchart 900 provides steps by which the media is provided to the original requesting user.

The method begins at step 902 and proceeds to step 904 where a user requests a download of their award from media staging area 626, in accordance with an embodiment of the present invention. In accordance with a further embodiment of the present invention, this download request is provided by an agent software component installed on client device 616. Additional functionality of this agent software is described below.

At step 906, transfer of the award begins from media staging area 626 to user device 616, in accordance with an embodiment of the present invention. A determination is then made at step 908 as to whether the transfer was successful. If not, then the transfer is retried at step 910 until it is successful. This determination is made, in accordance with an embodiment of the present invention, by receiving a transmission from agent software executing on client device 616 that indicates whether or not the transmission is complete.

When the transmission has been successful, the method proceeds to step 912 where the copy of the award stored at media staging area 626 is destroyed. This allows content manager 602 to transfer the award to client device 616 while still meeting common media licensing terms requiring the existence of only a single copy of the media at any given time. The method then ends at step 914.

In accordance with an embodiment of the present invention, as noted above, download request 904 is initiated by agent software installed on client device 616. In accordance with a further embodiment of the present invention, this agent software is configured to provide a number of services, such as the aforementioned download manager capabilities.

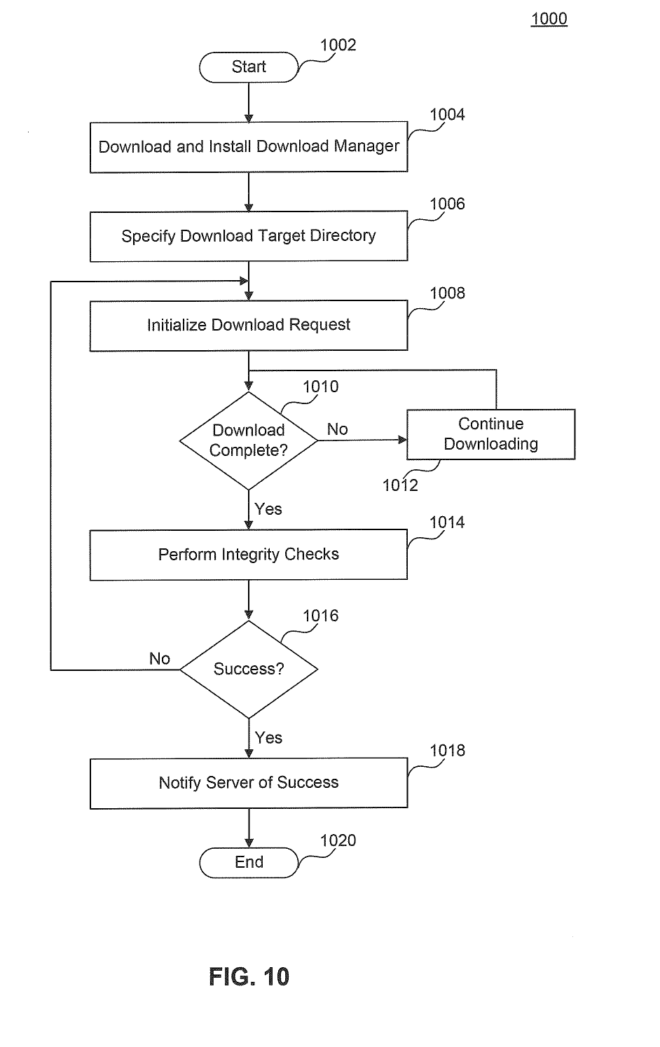

FIG. 10 is a flowchart 1000 illustrating download manager capabilities of the agent software, in accordance with an embodiment of the present invention. The method begins at step 1002 and proceeds to step 1004 where the download manager (i.e., agent software) is downloaded and installed. In accordance with an embodiment of the present invention, a user of client device 616 is prompted to download and install the download manager upon first accessing or creating their account. In accordance with an additional embodiment of the present invention, the user is prompted when they first attempt to download an award. One skilled in the relevant arts will recognize that a number of approaches for offering download and installation services exist, and the aforementioned approaches are provided by way of example, and not limitation.

Upon downloading the agent software, it is possible to specify a target directory at step 1006 for storing downloaded awards, in accordance with an embodiment of the present invention. In accordance with a further embodiment of the present invention, this target directory can be set or modified through a set of preferences subsequent to installation of the agent software. One skilled in the relevant arts will recognize that installation 1004 and configuration 1006 of the agent software does not need to be performed every time the agent software is to be used.

At step 1008, a download request is initialized, in accordance with an embodiment of the present invention. The download request is initialized, for example, by redeeming an offer such as by the steps shown in flowchart 800 of FIG. 8, in accordance with an embodiment of the present invention. As previously disclosed, in accordance with an embodiment of the present invention, an award (or other data) to be downloaded is held in media staging area 626 of FIG. 6. The agent software running on client 616 is configured to, for example, communicate with media acquisition module 624 or other appropriate component of content manager 602 in order to determine what downloads are being held for the agent software in media staging area 626. This is accomplished through the use of a Data Access Object (DAO) to encapsulate access to a database, in accordance with an embodiment of the present invention.

The agent software uses the aforementioned target directory to store downloads being received from media staging area 626, in accordance with an embodiment of the present invention. In accordance with a further embodiment of the present invention, the agent software shows information about the downloads as they are being received, including a media type (e.g., music, movie, etc.), a media title (e.g., track name, movie title, etc.), and a status for the download, such as a progress bar. In accordance with an embodiment of the present invention, each of the downloads corresponds to an item within the cart of step 806 of FIG. 8.

At step 1010, a determination is made as to whether a download has completed, and, if not, the method proceeds to step 1012 where the agent software continues the download. If the download is complete, however, the agent software performs integrity checks on the download at step 1014, in accordance with an embodiment of the present invention. Integrity checks include, by way of example and not limitation, calculation and testing of a checksum to insure that transmission was complete and clean, in accordance with an embodiment of the present invention.

The success of the integrity checks is determined at step 1016, in accordance with an embodiment of the present invention. If the download was not successful, such as demonstrated through an error in the checksum calculations, then the method proceeds to step 1008 where the download is restarted, in accordance with an embodiment of the present invention. The agent software may be configured to provide some visual indication to a user of a download failure, such as by highlighting the information about the download in red and providing a button or other option for manually restarting the download, in accordance with an embodiment of the present invention. One skilled in the relevant arts will recognize that a number of methodologies exist for handling a failed download, and the aforementioned methods are provided by way of example, and not limitation.

In the event that the download has been verified as successful, the agent software notifies media acquisition module 624 or other appropriate component of content manager 602 of the success at step 1018, in accordance with an embodiment of the present invention. This enables the content manager, by way of example and not limitation, to destroy the copy of the download being held in media staging area 626, such as by the method previously described at step 912 of FIG. 9. The method then ends at step 1020.

### VII. Remote Site Point Acquisition

The presence of the agent software on client device 616 also provides other functionality that enhances the services provided by content manager 602. In accordance with an embodiment of the present invention, the agent software can track web site accesses by a user of client device 616 in order to provide additional integration with content manager 602, including, by way of example and not limitation, information to assist in updating demographic information, as well as extending the award methodology described in, for example, flowchart 400 of FIG. 4 to affiliates.

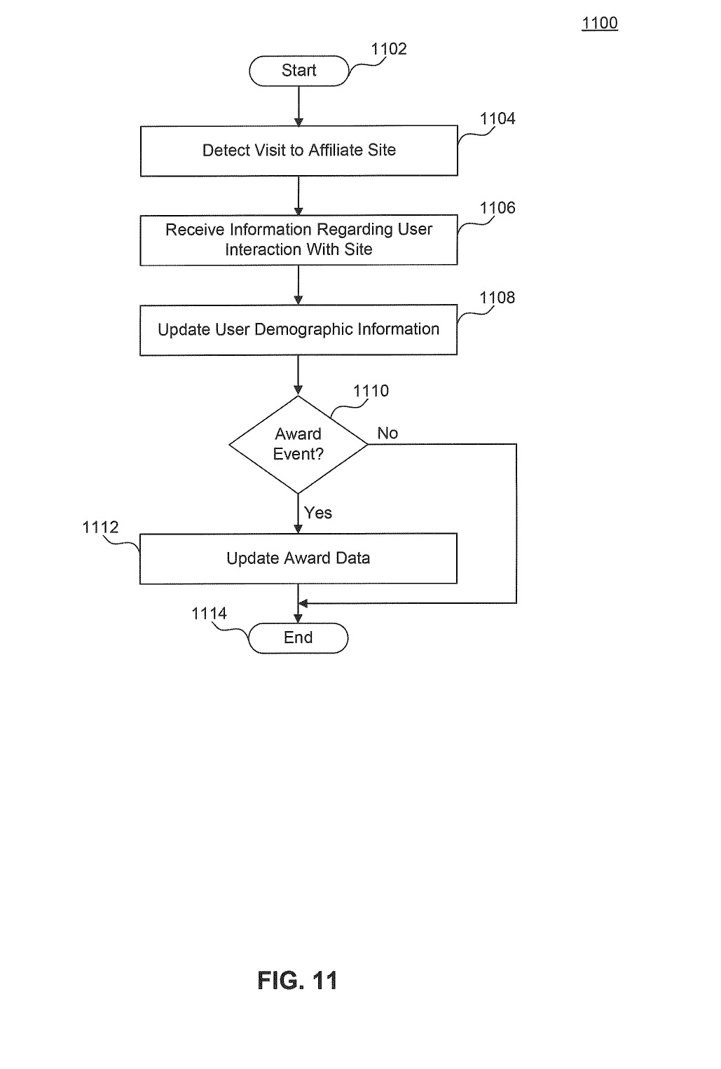

FIG. 11 is a flowchart 1100 illustrating steps by which the agent software is able to extend functionality to affiliate sites, in accordance with an embodiment of the present invention. The method starts at step 1102 and proceeds to step 1104 where the agent software detects a visit to an affiliate site on client device 616, in accordance with an embodiment of the present invention. This is accomplished, by way of example and not limitation, through monitoring of URLs accessed on a web browser of client device 616 for a known affiliate URL. An updated list of these known affiliate URLs is received by the software agent at certain periodic intervals, or when the software agent is first started, in accordance with an embodiment of the present invention.

At step 1106, the software agent receives information on a user of client device 616's activities on the affiliate site, in accordance with an embodiment of the present invention. In accordance with an embodiment of the present invention, this includes watching an advertisement and answering a question at the affiliate site using advertisements and questions provided by the same methodology of flowchart 400 of FIG. 4. In accordance with a further embodiment of the present invention, an operator of the affiliate site can define events to be monitored, such as answering a site polling question or registering to be a member of the affiliate site. In accordance with an additional embodiment of the present invention, the monitored events are based on a submission action, where data is sent from a web browser on client device 616 to the affiliate site.

It is possible to use information regarding a user's interaction with the affiliate site to update the user's demographic information, such as demographic information maintained in user profile information module 106 of FIG. 1, in accordance with an embodiment of the present invention. At step 1108, user demographic information is updated based on information submitted to the affiliate site, in accordance with a further embodiment of the present invention. The techniques by which demographic information is obtained and used to update user profile information 106 are further described below.

The information regarding the user's interaction with the affiliate site is reviewed at step 1110 to determine whether it corresponds to an award event. In accordance with an embodiment of the present invention, the operator of the affiliate site can choose certain monitored events for an award of points. These points are awarded to a user for storage in award database 322, and can be used as with any other awards, such as those obtained through interaction with content manager 302 by the methodology shown in flowchart 400 of FIG. 4, in accordance with an embodiment of the present invention. If the user's interaction was an award event, then the user's award data at award database 322 is updated accordingly at step 1112, or otherwise the method proceeds to step 1114. One skilled in the relevant arts will recognize that the publication of awards may be made to any database, and the use of award database 322 is provided by way of example, and not limitation. The method then ends at step 1114.

In accordance with an embodiment of the present invention, the operator of the affiliate site selects from certain predefined categories of monitored events for which to award points. These points are provided to a user who has performed the awarded monitored event by transferring points from the operator's account, in accordance with a further embodiment of the present invention. By way of example, and not limitation, this transfer can be performed by awarding points that the operator has prepaid for, or charging or invoicing the operator's account. One skilled in the relevant arts will appreciate that a number of methodologies exist by which the operator of the affiliate site can provide compensation in exchange for the ability to provide awards, and the aforementioned methods are provided by way of example and not limitation.

### VIII. Advertising Demographic Verification System

As previously discussed with regard to flowchart 200 of FIG. 2, a user creating an account with content manager 102 may provide answers to certain requests for demographic information at step 208, in accordance with an embodiment of the present invention. Some users may provide false demographic information out of a lack of trust for content manager 102. For other users, the demographic information may initially be correct, but may become out of date in certain situations, such as if the user moves to another state or country.

Many systems that collect demographic information rely on the information to be correct as entered by the user. To protect against privacy concerns, content manager 102 is configured, in accordance with an embodiment of the present invention, to analyze all users' demographic information and provide only statistical results for viewing. However, a significant amount of incorrect demographic information can impact the accuracy of these results.

The accuracy of demographic information for a user is important in, for example, selecting appropriate advertisements for display as in step 404 of FIG. 4 as described above, in accordance with an embodiment of the present invention. Advertisers use demographic information to gauge the effectiveness of their advertising choices, and therefore it is important for an advertising platform to provide advertisers with quality information regarding demographics.

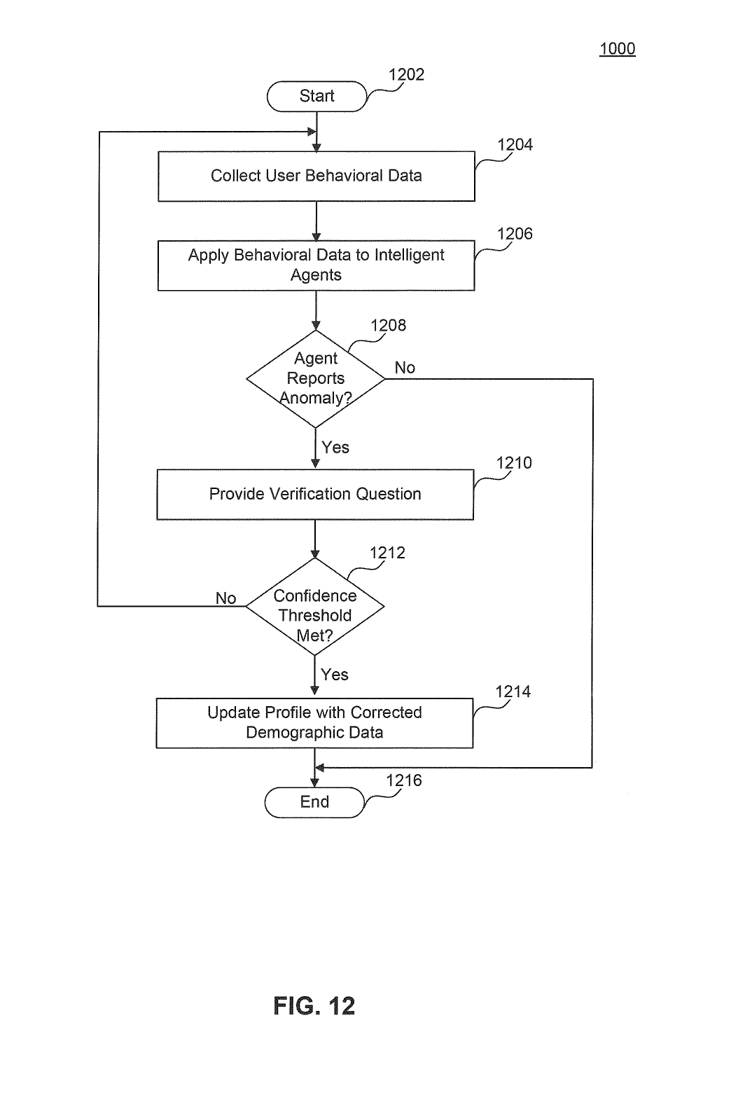

FIG. 12 is a flowchart 1200 illustrating steps by which an intelligent agent is configured to refine demographic information for a user, in accordance with an embodiment of the present invention. The method begins at step 1202 and proceeds to step 1204 where user behavioral data is collected, in accordance with an embodiment of the present invention. User behavioral data can include, by way of example and not limitation, information such as a user's interaction with an affiliate site as described above with regard to step 1106 of FIG. 11, the types of awards a user redeems (e.g., music genres in the case of MP3 download awards), and answers and attitudes towards particular advertisements. One skilled in the relevant arts will appreciate that other opportunities exist in the systems and methods described herein for collection of user behavioral data, and the aforementioned opportunities are provided by way of example, and not limitation.

Using the acquired behavioral information, it is possible to run a number of intelligent agents, ontologies, learning neural networks, or other such software agents (collectively “intelligent agents”) on the behavioral information in order to identify any potential anomalies. At step 1206, the behavioral information is provided to an intelligent agent for processing. These intelligent agents are constantly updated with the latest intelligence on demographic preferences in order to discover anomalies in user activity that appear to be outside of normal preferences for demographic information currently associated with the user, in accordance with an embodiment of the present invention. Techniques regarding the accumulation of self-learning data are known in the art in, for example, U.S. Pat. No. 6,714,975 to Aggarwal et al., filed Mar. 31, 1997, issued Mar. 30, 2004, which is incorporated herein by reference in its entirety.

The results of the intelligent agents' processing are reviewed at step 1208. If the applied intelligent agents report no anomalies, then the method ends at step 1216. However, if there is an anomaly reported, then the intelligent agents take steps to correct the demographic data, if possible.

In accordance with an embodiment of the present invention, a verification question is provided at step 1210 in order to allow the user an opportunity to correct demographic data. By way of example and not limitation, this verification question can be a same question asked of the user during a registration process, such as during step 208 of FIG. 2, or may be a question asked in order to derive the desired demographic information in a subtle manner.

To reduce the likelihood that a user will falsify their answer to the verification question, the intelligent agent is configured to wait a certain period of time subsequent to user registration before presenting the verification question, in accordance with an embodiment of the present invention. For example, the intelligent agent may be configured to wait several weeks or months before asking a verification question in order to allow a user sufficient time to forget their answers to demographic questions asked during registration.

At this point, even if the user falsifies the answer, it will likely not match the answer provided at registration, thereby providing further evidence that demographic information for the user is incorrect. Waiting for a certain time period after registration before providing the verification question to the user also allows the user to become comfortable with their actions on the system, and provides the intelligent agent with sufficient time to establish, such as through step 1206, that the user has deviated from an established base profile for their demographic information as provided during registration. In accordance with a further embodiment of the present invention, if a user's responses to the verification question are clearly erroneous, the intelligent agent is configured to continue asking verification questions until the user responds correctly or with some answer which is plausibly correct based on information known about the user.

At step 1212, a determination is made as to whether a confidence threshold has been met regarding corrected demographic information for the user, in accordance with an embodiment of the present invention. For example, the intelligent agent may be configured to require a 99.9% confidence level regarding a change to a user's demographic data before applying the change. One skilled in the relevant arts will recognize that the precise confidence threshold may vary with particular applications of the techniques described herein, and the use of a high confidence level is provided by way of example, and not limitation.

If the confidence threshold has not been met, then the method proceeds to step 1204 to collect additional data on the user for analysis. However, if the confidence threshold has been met, then the method proceeds to step 1214 where the user's demographic information is corrected, in accordance with an embodiment of the present invention. For example, incorrect user-supplied demographic information held in user profile information module 106 may be revised to instead include the demographic information derived through the steps of flowchart 1200. The method then ends at step 1216.

### IX. Example Computer System Implementation

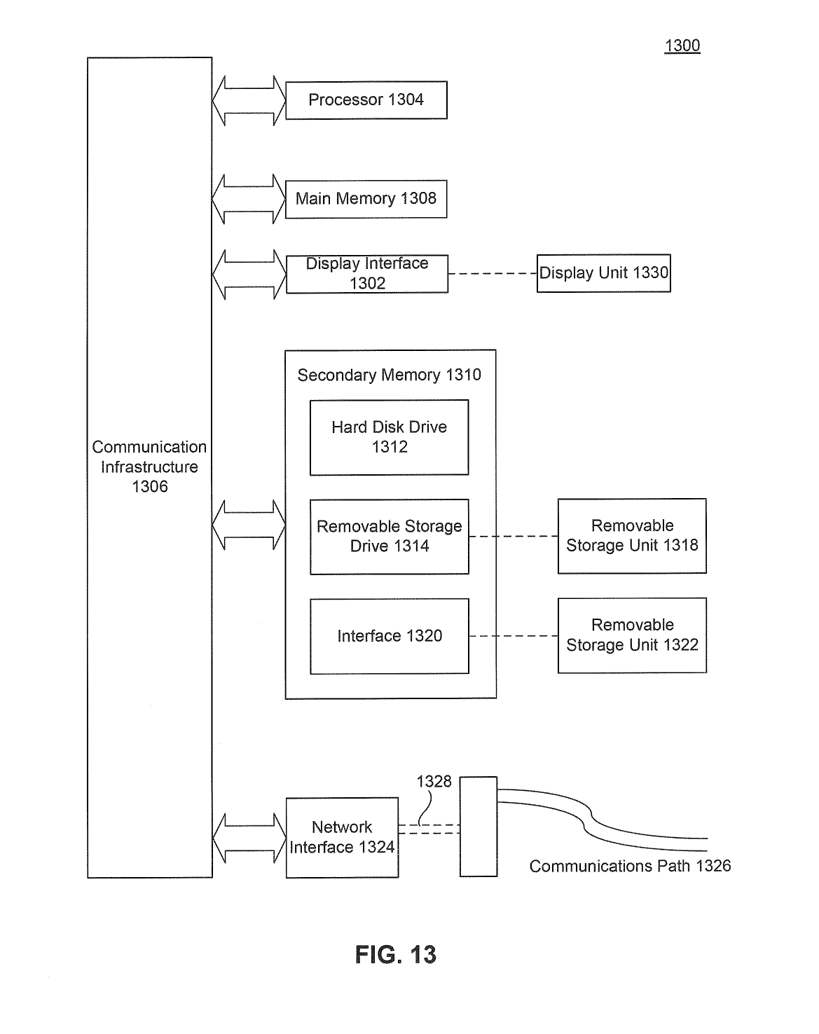

Various aspects of the present invention can be implemented by software, firmware, hardware, or a combination thereof. FIG. 13 illustrates an example computer system 1300 in which the present invention, or portions thereof, can be implemented as computer-readable code. For example, the methods illustrated by flowcharts 200 of FIG. 2, 400 of FIG. 4, 700 of FIG. 7, 800 of FIG. 8, 900 of FIG. 9, 1000 of FIG. 10, 1100 of FIG. 11, and 1200 of FIG. 12, can be implemented in system 1300. Various embodiments of the invention are described in terms of this example computer system 1300. After reading this description, it will become apparent to a person skilled in the relevant art how to implement the invention using other computer systems and/or computer architectures.

Computer system 1300 includes one or more processors, such as processor 1304. Processor 1304 can be a special purpose or a general purpose processor. Processor 1304 is connected to a communication infrastructure 1306 (for example, a bus or network).

Computer system 1300 also includes a main memory 1308, preferably random access memory (RAM), and may also include a secondary memory 1310. Secondary memory 1310 may include, for example, a hard disk drive 1312, a removable storage drive 1314, and/or a memory stick. Removable storage drive 1314 may comprise a floppy disk drive, a magnetic tape drive, an optical disk drive, a flash memory, or the like. The removable storage drive 1314 reads from and/or writes to a removable storage unit 1318 in a well known manner. Removable storage unit 1318 may comprise a floppy disk, magnetic tape, optical disk, etc. that is read by and written to by removable storage drive 1314. As will be appreciated by persons skilled in the relevant art(s), removable storage unit 1318 includes a computer usable storage medium having stored therein computer software and/or data.

In alternative implementations, secondary memory 1310 may include other similar means for allowing computer programs or other instructions to be loaded into computer system 1300. Such means may include, for example, a removable storage unit 1322 and an interface 1320. Examples of such means may include a program cartridge and cartridge interface (such as that found in video game devices), a removable memory chip (such as an EPROM, or PROM) and associated socket, and other removable storage units 1322 and interfaces 1320 that allow software and data to be transferred from the removable storage unit 1322 to computer system 1300.

Computer system 1300 may also include a communications interface 1324. Communications interface 1324 allows software and data to be transferred between computer system 1300 and external devices. Communications interface 1324 may include a modem, a network interface (such as an Ethernet card), a communications port, a PCMCIA slot and card, or the like. Software and data transferred via communications interface 1324 are in the form of signals that may be electronic, electromagnetic, optical, or other signals capable of being received by communications interface 1324. These signals are provided to communications interface 1324 via a communications path 1326. Communications path 1326 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 1318, removable storage unit 1322, and a hard disk installed in hard disk drive 1312. Signals carried over communications path 1326 can also embody the logic described herein. Computer program medium and computer usable medium can also refer to memories, such as main memory 1308 and secondary memory 1310, which can be memory semiconductors (e.g. DRAMs, etc.). These computer program products are means for providing software to computer system 1300.

Computer programs (also called computer control logic) are stored in main memory 1308 and/or secondary memory 1310. Computer programs may also be received via communications interface 1324. Such computer programs, when executed, enable computer system 1300 to implement the present invention as discussed herein. In particular, the computer programs, when executed, enable processor 1304 to implement the processes of the present invention, such as the steps in the methods illustrated by flowcharts 200 of FIG. 2, 400 of FIG. 4, 700 of FIG. 7, 800 of FIG. 8, 900 of FIG. 9, 1000 of FIG. 10, 1100 of FIG. 11, and 1200 of FIG. 12, discussed above. Accordingly, such computer programs represent controllers of the computer system 1300. Where the invention is implemented using software, the software may be stored in a computer program product and loaded into computer system 1300 using removable storage drive 1314, interface 1320, hard drive 1312 or communications interface 1324.

The invention is also directed to computer program products comprising software stored on any computer useable medium. Such software, when executed in one or more data processing device, causes a data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

### X. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. It should be understood that the invention is not limited to these examples. The invention is applicable to any elements operating as described herein. Accordingly, the breadth and scope of the present invention should not be limited by any of the above-described exemplary embodiments, but should be defined only in accordance with the following claims and their equivalents.

What is claimed is:

1. A method comprising:
providing an advertisement;
presenting a question based on the advertisement;
receiving an answer to the question; and
updating, by one or more computing devices, an award database to reflect an award, wherein the answer is correct.

2. The method of claim 1, further comprising:
recording statistical data regarding the answer.

3. The method of claim 1, further comprising:
providing an award redemption offer corresponding to a vendor's offering;
receiving a request to redeem the award for the award redemption offer; and
deducting the award from the award database.

4. The method of claim 3, further comprising:
purchasing the vendor's offering from the vendor;
storing the vendor's offering in a staging area; and
providing the vendor's offering from the staging area to a download agent.

5. The method of claim 4, further comprising:
receiving an indication that the vendor's offering has been successfully provided to the download agent; and
deleting the vendor's offering from the staging area.

6. The method of claim 3, wherein the vendor's offering is an MP3 audio file.

7. The method of claim 1, further comprising:
determining demographic information regarding a target viewer of the advertisement.

8. The method of claim 7, further comprising:
selecting the advertisement based on the demographic information.

9. The method of claim 7, further comprising:
selecting the question based on the demographic information.

10. The method of claim 7, wherein determining the demographic information comprises:
accessing demographic information from a user profile corresponding to the target viewer.

11. The method of claim 10, further comprising:
collecting behavioral data for a target viewer of the advertisement;
analyzing the behavioral data with an intelligent agent;
detecting an anomaly between expected demographic data based on the analysis and the demographic information from the user profile; and
updating the user profile with the expected demographic data.

12. The method of claim 11, wherein the behavioral data comprises one or more of:
interaction events performed on an affiliate site;
requests for award redemption offers; and
answers and attitudes towards advertisements presented to the target viewer.

13. The method of claim 10, further comprising:
providing a verification question to the target viewer;
determining supplemental demographic information based on an answer to the verification question; and
comparing the supplemental demographic information with the demographic information from the user profile.

14. A computer-readable storage medium having instructions stored thereon that, when executed by a computing device, cause the computing device to perform a method comprising:
providing an advertisement;
presenting a question based on the advertisement;
receiving an answer to the question; and
updating an award database to reflect an award, wherein the answer is correct.

15. The computer-readable storage medium of claim 14, the method further comprising:
recording statistical data regarding the answer.

16. The computer-readable storage medium of claim 14, the method further comprising:
providing an award redemption offer corresponding to a vendor's offering;
receiving a request to redeem the award for the award redemption offer; and
deducting the award from the award database.

17. The computer-readable storage medium of claim 16, the method further comprising:
purchasing the vendor's offering from the vendor;
storing the vendor's offering in a staging area; and
providing the vendor's offering from the staging area to a download agent.

18. The computer-readable storage medium of claim 17, the method further comprising:
receiving an indication that the vendor's offering has been successfully provided to the download agent; and
deleting the vendor's offering from the staging area.

19. The computer-readable storage medium of claim 16, wherein the vendor's offering is an MP3 audio file.

20. The computer-readable storage medium of claim 14, the method further comprising:
determining demographic information regarding a target viewer of the advertisement.

21. The computer-readable storage medium of claim 20, the method further comprising:
selecting the advertisement based on the demographic information.

22. The computer-readable storage medium of claim 20, the method further comprising:
selecting the question based on the demographic information.

23. The computer-readable storage medium of claim 20, wherein determining the demographic information comprises:
accessing demographic information from a user profile corresponding to the target viewer.

24. The computer-readable storage medium of claim 23, the method further comprising:
collecting behavioral data for a target viewer of the advertisement;
analyzing the behavioral data with an intelligent agent;
detecting an anomaly between expected demographic data based on the analysis and the demographic information from the user profile; and
updating the user profile with the expected demographic data.

25. The computer-readable storage medium of claim 24, wherein the behavioral data comprises one or more of:
interaction events performed on an affiliate site;
requests for award redemption offers; and
answers and attitudes towards advertisements presented to the target viewer.

26. The computer-readable storage medium of claim 23, the method further comprising:
providing a verification question to the target viewer;
determining supplemental demographic information based on an answer to the verification question; and
comparing the supplemental demographic information with the demographic information from the user profile.

27. A system comprising:
a memory configured to store modules, the modules comprising:
a providing module configured to provide an advertisement,
a presenting module configured to present a question based on the advertisement,
a receiving module configured to receive an answer to the question, and
an updating module configured to update an award database to reflect an award, wherein the answer is correct; and
a processor configured to process the modules.

28. A method comprising:
receiving, by one or more computing devices, a request to purchase an electronic media file from an intermediary for provision to a user device based on redemption of an award;
providing the electronic media file to the intermediary; and
confirming deletion of the electronic media file by the intermediary subsequent to provision of the electronic media file to the user device by the intermediary.

29. A method comprising:
uploading, by one or more computing devices, an advertisement for presentation to a user;
uploading, by the one or more computing devices, a question for presentation to the user, and a correct answer, wherein the user is presented with the question upon viewing the complete advertisement;
configuring demographic information corresponding to target users for the advertisement; and
monitoring statistical information of answers chosen by the user.

30. A method comprising:
detecting, by one or more computing devices, a visit to an affiliate site from an affiliate site list;
receiving notification of an event on the affiliate site;
determining whether the event is an award event; and
updating a central award database based on the award event.

31. The method of claim 30, further comprising:
archiving the event; and
analyzing the event and one or more additional events to determine a user's demographic information.

32. The method of claim 30, further comprising:
viewing a list of rewards; and
selecting one of the rewards for redemption using awards from the central award database.

33. The method of claim 32, wherein awards are deducted from the central award database based on selection of the reward.

34. The method of claim 32, further comprising:
downloading, using a download agent, an electronic file corresponding to the reward; and
notifying a download server when the electronic file has been successfully downloaded.

35. The method of claim 34, further comprising:
performing an integrity check on the electronic file, wherein the electronic file is deemed to have been successfully downloaded upon successful verification of the integrity check.
